(19) United States
(12) Patent Application Publication
(10) Pub. No.: US 2002/0136818 A1
(43) Pub. Date: Sep. 26, 2002

(54) Food products containing high melting emulsifiers

(76) Inventors: Shantha C. Nalur, New Milford, CT (US); Guillermo E. Napolitano, Dublin, OH (US)

Correspondence Address: WINSTON & STRAWN, 200 PARK AVENUE, NEW YORK, NY, 10166-4193, US

(21) Appl. No.: 09/729,693

(22) Filed: Dec. 6, 2000

Related U.S. Application Data
(60) Provisional application No. 60/221,136, filed on Jul. 27, 2000.

(51) Int. Cl. A23C 1/00

(52) U.S. Cl. 426/631; 426/660

(57) ABSTRACT

The invention is directed to food products that include a liquid fat and a high melting point emulsifier. The liquid fat and a high melting point emulsifier can replace solid fat in the food product. The high melting point emulsifier may also be added to chocolate to provide a chocolate composition that has better shape retention at elevated temperatures. The emulsifier component gives the fat in the chocolate a structure that resists loss of shape even at elevated temperatures and keeps the chocolate composition from sticking to the wrapper when subjected to elevated temperatures. The invention also provides a method of making the chocolate composition.

### CROSS REFERENCE TO RELATED APPLICATIONS

This application claims priority to U.S. provisional Application No. 60/221,136, filed Jul. 27, 2000, the content of which is expressly incorporated herein by reference thereto.

### TECHNICAL FIELD

The invention relates to food products containing a high melting point emulsifier component. In particular, chocolate compositions wherein a high melting point emulsifier component is included in the chocolate to form a heat resistant chocolate composition and a method of manufacturing the chocolate composition.

### BACKGROUND OF THE INVENTION

Melting of chocolate is an inherent problem in tropical and subtropical countries and in markets that lack an adequate distribution system. Products that include chocolate readily melt at warmer temperatures so that the product fails to retain its shape. Also, the melted product often sticks to the wrapper that surrounds the product. Attempts to produce chocolate and chocolate containing products that retain their shape are based on the hypothesis that glycerin can link the sugar particles together to generate a three dimensional network that provides structural stability to the chocolate. The process for producing shape retaining chocolates using this technology, however, involves the complex process of forming a stable emulsion system wherein glycerin is immobilized in carrageenan. Thus, there remains a need for chocolate compositions that retain their shape at elevated temperatures and for methods to manufacture these improved chocolates.

### SUMMARY OF THE INVENTION

The invention relates to a chocolate composition comprising an emulsifier component having a melting point from about 50 to 90° C. and a hydrophilic lipophilic balance value of about 2 to 10. The emulsifier component may be present in an amount of about 1 to 6 percent by weight of the confectionery product.

The emulsifier component may include one or more of a diacetyltartaric acid ester of monoglycerides, sorbitan esters, mono- and diglycerides of vegetable oils, partially hydrogenated monoglycerides, fully hydrogenated monoglycerides, or sugar esters.

In one embodiment the emulsifier component includes a monoglyceride having a carbon side chain of at least 18 carbons. In another embodiment, the emulsifier component includes a monoglyceride having a carbon side chain of at least 20 carbons. The emulsifier component may include a monoglyceride having a melting point of about 67° C. and can be obtained by distilling partially hydrolyzed vegetable oil. The chocolate compositions preferably maintain their structure up to a temperature of at least about 36° C. In another embodiment the chocolate compositions maintain their structure up to a temperature of at least about 45° C.

The invention also relates to a method of manufacturing the chocolate compositions. The method involves combining the ingredients of the chocolate; adding an emulsifier component to the chocolate, the emulsifier having a melting point from about 50 to 90° C. and a hydrophillic lipophilic balance value of about 2 to 10; mixing the chocolate and emulsifier component to sufficiently distribute the emulsifier component throughout the chocolate to provide a chocolate composition that includes a mixture of chocolate and emulsifier component; warming the chocolate composition to a temperature sufficient to prevent the emulsifier component from crystallizing; and allowing the mixture to cool and set. The method may further include depositing the mixture into a mold at a temperature sufficient to prevent the emulsifier component from crystallizing and removing the mixture from the mold after the mixture cools. The emulsifier component may be added in an amount from about 1 to 4.5 percent by weight of the chocolate composition. Preferably the mixing uniformly distributes the emulsifier component throughout the chocolate.

The invention further relates to food products comprising a liquid oil and an emulsifier component having a melting point from about 50 to 90° C. and a hydrophillic lipophilic balance value of about 2 to 10. The liquid oil may be palm oil, palm kernel oil, coconut oil, cocoa butter, babassu oil, milk fat, soybean oil, corn oil, canola oil, rapeseed oil, sesame oil, sunflower oil, safflower oil, peanut oil, oils resulting from the fractionation or hydrogenation thereof and mixtures thereof. The ratio of liquid oil to emulsifier component may be about 10:2. The emulsifier component may be at least one of a diacetyltartaric acid ester of a monoglyceride, sorbitan ester, mono- or diglyceride of a vegetable oils, a partially hydrogenated monoglyceride, a fully hydrogenated monoglyceride or a sugar esters. The emulsifier component may be a monoglyceride having a carbon side chain of at least 18 carbons. The liquid oil maybe present in an amount of about 1 to 60 weight percent of the food product and the emulsifier may be present in an amount of about 0.5 to 15 weight percent of the liquid oil. The food product may be a creamer, dough, bouillon bases, confectionery coating, or ice cream.

### BRIEF DESCRIPTION OF THE DRAWINGS

Further features and advantages of the invention can be ascertained from the following detailed description that is provided in connection with the drawings described below:

FIG. 1 depicts the structure of a fat, at 36° C., containing no emulsifier component, containing lecithin, and containing a monoglyceride having a melting point of about 67° C. obtained by distilling partially hydrolyzed vegetable oil;

FIG. 2 depicts the texture profile of a compound coating containing a high melting point emulsifier component of the invention and a compound coating without an emulsifier component;

FIG. 3 depicts the effect of elevated temperature on a confectionery product made with a compound coating containing a high melting point emulsifier component of the invention compared to a confectionery product containing a compound coating without an emulsifier component.

### DETAILED DESCRIPTION OF THE PREFERRED EMBODIMENTS

The present invention provides food compositions containing a high melting point emulsifier. In particular, a chocolate composition prepared by adding a high melting point emulsifier component to the chocolate that has improved resistance to heat and better shape retaining properties at elevated temperatures than conventional chocolate. The high melting point emulsifier component imparts a rigidity to the fat present in the chocolate that helps inhibit or prevent changes in the shape of the chocolate composition at elevated temperatures. The structure of the chocolate composition can be substantially maintained even at temperatures as high as 36° C., as high as 40° C., and more preferably as high as 45° C. The use of a high melting point emulsifier component also keeps the chocolate composition from sticking to the wrapper when it is subjected to elevated temperatures such as are generally incurred in hot summer days or in tropical countries.

The present invention relies on a completely different approach to manufacture a chocolate composition with improved heat resistance than prior art processes that rely on linking sugar particles with glycerin. The improved heat resistance in the chocolate composition of the invention is obtained by incorporating structural ingredients, i.e., one or more high melting point emulsifier components, into the chocolate to modify the fat phase of the chocolate.

The term “chocolate,” as used herein, means any confectionery product having qualities sufficient to impart chocolate taste and character. Suitable chocolates include, but are not limited to, sweet chocolate, milk chocolate, buttermilk chocolate, bittersweet chocolate, and chocolates as defined in 21 C.F.R. §163. “Chocolate” also includes compound coatings that have a chocolate flavor and any other material that functions as a chocolate analogue or a chocolate substitute. Compound coatings are chocolate like products that contain other vegetable fats in addition to or in place of cocoa butter. The invention is also useful with non-chocolate confectionery coatings, such as, for example, fat based Irish creme coatings and peanut butter coatings. The term “confectionery coating,” as used herein, means any fat based composition used in a confectionery product.

The term “emulsifier component,” as used herein, means a compound or additive that has a hydrophillic and hydrophobic moiety and can be used to form a stable mixture of two or more immiscible phases. Generally, the immiscible phases are a hydrophobic liquid and a hydrophilic liquid. In chocolate, a fat phase is the hydrophobic phase and sugar and cocoa provide the hydrophillic sites.

The emulsifier component is added to the chocolate in an amount of between about 1 and 6 percent by weight of the chocolate composition (i.e., between about 3 and 15 percent of the fat phase), preferably from about 2 and 4.5 percent by weight of the chocolate composition, and more preferably from about 2.2 to 3 percent by weight of the chocolate composition. Conventional emulsifiers may also be included. Although it is conventional to add emulsifiers to chocolate, such conventional emulsifiers are typically added in much lower amounts than required by the invention. Typically emulsifiers are only added in an amount of between about 0.01 and 0.5 percent by weight of the chocolate composition. Furthermore, the emulsifiers that are conventionally added to chocolate are different from the high melting point emulsifier components of the invention.

The emulsifier component of the invention can have a melting point from about 50° C. and 90° C., preferably from about 57° C. and 80° C., and most preferably from about 60° C. and 75° C. For example, a monoglyceride emulsifier with a melting point about 67° C. obtained by distilling partially hydrolyzed vegetable oil works well.

Each emulsifier also preferably has a hydrophilic lipophilic balance (HLB) value from about 2 to 10, preferably from about 3 to 8, and more preferably from about 4 to 7. HLB is well known to those of ordinary skill in the art and measures the affinity of an emulsifier for water or oil on a scale of 1 to 20. The higher the number the greater the affinity of the emulsifier for water, the lower the number the greater the affinity of the emulsifier for oil. It is important that the emulsifier have an HLB value within the recited ranges. If the HLB value is too low the chocolate composition, containing the emulsifier, has a waxy texture. If the HLB value of the emulsifier is too high, the emulsifier is too water soluble and separates from the fat.

Any emulsifier having these properties can be used. Examples of emulsifiers useful in the chocolate compositions of the invention include, but are not limited to, DATEM (diacetyltartaric acid ester of monoglycerides), sorbitan esters, mono- and diglyceride esters of vegetable oils, partially and fully hydrolyzed monoglycerides, sugar esters and the like, or combinations thereof.

The preferred emulsifier components are monoglycerides. Preferably, the length of the hydrocarbon side chain of the monoglyceride is at least 16 carbons long, preferably at least 18 carbons long, and more preferably at least 20 carbons long. These monoglycerides have high melting points, but they contain a hydrophilic moiety, which interacts with the saliva so that they are not perceived as “waxy” in the mouth at the concentrations described in this invention. Partially hydrolyzed and fractionated vegetable oil having a melting point of about 67° C. also works well in the emulsifier component. Preferably, the partially hydrolyzed vegetable oil is distilled to purify it and remove a portion of the diglycerides and triglycerides, more preferably to remove substantially all the diglycerides and triglycerides.

The chocolate compositions of the invention are made by adding the high melting point emulsifier component to the chocolate during the manufacturing process. The high melting point emulsifier component can be combined with the ingredients of the chocolate product at any time. For example, the emulsifier component may be added before or after conching. The high melting nature of the emulsifier component, however, requires that the chocolate compositions are deposited into molds at a high temperature. The depositing temperature needs to be sufficiently high to inhibit or prevent the emulsifier component from crystallizing. It is also preferable to deposit the chocolate composition into warm molds. The chocolate composition is then allowed to cool. The presence of the high melting emulsifier component accelerates the setting of the chocolate composition. After the chocolate composition sets the chocolate composition is removed from the mold.

The high melting point emulsifier component can advantageously be added to a variety of food products other than chocolate. The high melting point emulsifier(s) can be added to any food that contains solid fat. The term “solid fat,” as used herein means any fat that is a solid above about 0° C., preferably above about 10° C., more preferably above about 20° C. One or more high melting point emulsifier are combined with a liquid oil to replace the solid fat. The phrase “liquid oil,” as used herein, means any fat that is a liquid above 20° C., preferably above 0° C., more preferably above −20° C.

It is advantageous to replace solid fats with liquid oils, since solid fats typically need to be hydrogenated or fractionated before they are used, which can increase costs. Furthermore, it is desirable to replace the solid fats with liquid oils since liquid oils are healthier than solid fats. Solid fats typically are saturated or, if unsaturated, contain a significant amount of trans isomer double bonds. Both saturated fats and fats with trans isomer double bonds are less healthy than unsaturated fats or fats with trans isomer double bonds. In contrast, liquid oils have a higher degree of unsaturation and fewer trans double bonds. Generally, however, it is not possible to replace the solid fats with a liquid oil, since oiling out is a problem and can result in a visually unacceptable food product. The phrase “oiling out,” as used herein, means that the liquid oil separates from the other components of the food product. By combining the liquid oil with the high melting point emulsifier(s) of the invention the problem of oiling out is inhibited or even entirely avoided. Without wishing to be bound by theory it is believed that the high melting point emulsifier component forms a network that physically interacts with the liquid oil molecules and traps the liquid oil molecules to provide a structure that resists flow. The high melting emulsifier combined with a liquid oil may be used whenever oiling out is or may be a problem.

Representative liquid oils useful in the process of the invention include, but are not limited to palm, palm kernel oil, coconut oil, cocoa butter, babassu oil, milk fat, soybean oil, corn, canola, rapeseed, sesame, sunflower, safflower, peanut oil and those oils resulting from their fractionation or hydrogenation. The liquid oil may be present in an amount of about 1 to 60 weight percent of the food product, preferably about 5 to 50 weight percent of the food product, and more preferably about 10 to 35 percent by weight of the food product and the emulsifier may be present in an amount of about 0.5 to 15 weight percent of the liquid oil, preferably about 0.5 to 12 percent by weight of the liquid oil. Typically, the ratio of the liquid oil to the high melting point emulsifier is about 10:2, preferably 10:1, more preferably 10:0.5.

For example, the high melting point emulsifiers can be added to a creamer. The term “creamer,” as used herein means a non-dairy whitener or flavoring agent, in powder or liquid form, that is used as a replacement for milk. Typically, a creamer comprises a solid fat (typically a vegetable fat), water, and an emulsifier. The creamer may further comprise corn syrup solids, casein acid, sodium phosphate, mono- and diglycerol, sodium hydroxide lecithin, artificial colors, and flavors. The high melting point emulsifier component is added to the creamer in an amount of about 1 to 10 percent by weight of the creamer, preferably about 2 to 6 percent by weight of the creamer, and most preferably about 4.5 to 5 percent by weight of the creamer. The liquid oil is present in the creamer in an amount of about 15 to 40 percent by weight of the creamer, preferably about 25 to 35 percent by weight of the creamer. By using a high melting point emulsifier component it is possible to have creamer wherein the solid fat is partially or entirely replaced by one or more liquid oils. If the creamer is made with non-lauric oils, such as most vegetable oils, excluding coconut, palm kennel, and babussa oil, there is also a reduction in cost as they are cheaper in certain parts of the world in addition to their prices being more stable. These non-lauric oils are considered to be healthier than lauric oils. Although the creamer can be made from a liquid fat, the high melting point emulsifier holds up the liquid oil, i.e., provides a network structure, and prevents oiling out, to provide a creamer with a desirable powdery, non-sticky, texture.

The high melting point emulsifier component may also be used in fat-based confectionery coatings and centers. In particular, the high melting point emulsifier may be added to nut based confectionery coatings and centers. Typically, a nut based confectionery coating or center includes sugar and nut paste. The nuts may include, for example, peanuts, almonds, pecans, sunflower seeds, macadamian nuts, and the like. Typically, nuts contain about 50 percent by weight of liquid oil. The liquid oil often oils out and leaches into the coating (center) if the nut base is used as a center (coating). Adding a high melting point emulsifier component of the invention to the nut paste reduces or avoids oiling out. Generally, the high melting point emulsifier component of the invention is added in an amount of about 0.5 to 10 percent by weight of the oil in the nut paste.

In some nut based confectionery coatings and centers, additional solid fat is added to the nut paste. The solid fat may be added in an amount of 0 to about 20 percent by weight of the nut paste. It is possible to replace some of the solid fat with a liquid oil and a high melting point emulsifier component of the invention. Typically, from about 5 to 25 percent by weight of the fat is replaced with a liquid oil and the high melting point emulsifier component of the invention. The high melting point emulsifier is present in an amount of about 0.5% to 15% by weight of the oil phase. Using the high melting point emulsifiers advantageously allows liquid oils to replace the solid fat in confectionery coatings and centers and confers a heat resistance to the confectionery coating or center so that it can withstand the high temperatures needed for enrobing without the liquid oil oiling out.

The high melting point emulsifier may also be used in bouillon bases. The term “bouillon bases,” as used herein means a powder, paste, tablet or cube, that is used as a concentrate and is diluted with water to prepare a soup or broth. Typical ingredients in a bouillon base include salts; seasonings; flavor enhancers (such as monosodium glutamate); fat or oil (either vegetable or animal origin); and, optionally, meat, such as chicken, beef, pork, lamb, and vegetables. An exemplary bouillon base typically contains about 17 percent moisture and about 20 percent fat. The solid fat can then be replaced with a liquid oil and a high melting emulsifier according to the invention. Adding a high melting point emulsifier to the bouillon base holds up the liquid oil, prevents oiling out in these product, and gives form to the product. Typically, the bouillon base includes the liquid oil in an amount of about 5 to 35 percent and the high melting point emulsifier in an amount of about 0.5% to 15% by weight of the oil phase.

The high melting point emulsifier can also be added to baked food products that are made from dough including, but not limited to, breads, cakes, cookies, muffins, brownies, and the like. A typical dough formulation includes flour, water, and fat. The fat typically used in baking is a shortening (a hydrogenated fat) and can be replaced with a liquid fat to which a high melting point emulsifier component has been added. The high melting point emulsifier inhibits or prevents the liquid oil and prevents the liquid oil from oiling out or separating from the dough. The resulting baked product generally has a more airy texture when shortening is replaced with a liquid fat to which a high melting point emulsifier component has been added. Typically, the dough includes the liquid oil in an amount of about 5 to 35 percent by weight, preferably between about 10 to 30 percent by weight and the high melting point emulsifier in an amount of about 0.5 to 15 percent by weight of the oil, preferably about 5 to 10 percent by weight of the oil.

The high melting point emulsifier can also be used in ice cream products. Ice cream typically contains water, milk or vegetable fat, milk solids, sugar, stabilizers, emulsifiers, and flavoring. The fat in ice cream may be replaced with a liquid oil in combination with a high melting point emulsifier component. Typically, the ice cream includes the liquid oil in an amount of about 5 to 12 percent by weight, preferably about 8 to 10 percent by weight and the high melting point emulsifier in an amount of about 0.5 to 15 percent by weight of the oil, preferably of about 3 to 10 percent by weight of the oil.

In another embodiment of the invention, oiling out in a food product is inhibited or prevented by replacing some of the liquid oil with a solid fat. Typically, about 70 weight percent, preferably about 50 weight percent, and more preferably about 30 weight percent of the liquid oil is replaced with a solid fat. Generally, it is advantageous to add a high melting point emulsifier component to hold the liquid oil, however, in some cases the high melting point emulsifier produces a product that is texturally different from a product prepared without added high melting point emulsifier, for example, more airy or cakey. In order to avoid the textural difference in some food products, some of the oil may be replaced with a solid fat. For example, in a peanut butter dough the oil may be replaced with a shortening having approximately 50% liquid oil at 0° C. with a harder confectionery fat that has about 20% oil at 0° C. The resulting dough has pliability which is important for dough processing. The texture of the final product was very similar to the initial product, however, there was no oiling out in the dough

### EXAMPLES

The invention is further defined by reference to the following examples describing in detail the preparation of the chocolate composition of the present invention. The examples are representative, and they should not be construed to limit the scope of the invention in any way.

### Example 1

Assessing the Ability of Emulsifier Components to Maintain Fat Structure.

An emulsifier (1-6% by weight of the fat) was added with stirring to one hundred grams of melted fat. The temperature was maintained at 65° C. to allow the fat to completely melt. The mixture of fat and emulsifier was then placed in a refrigerator for between 30 min. and 1 hour to allow the fat to solidify. The beaker was then removed from the refrigerator and maintained at several different temperatures to see if the fat network maintained its structure.

Two fats, cocoa butter and a commercially available lauric confectionery fat were tested. Laurie fat is a substitute for cocoa butter. Laurie fat has a sharp melting point and is completely melted between about 32 and 34° C. Cocoa butter is the principal fat in all chocolates.

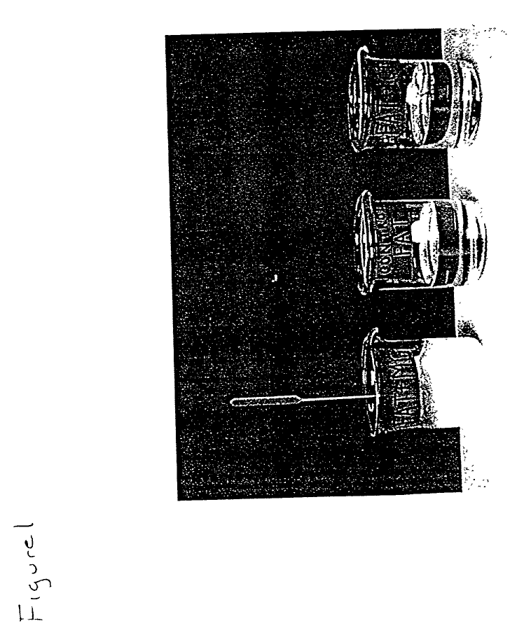

FIG. 1 shows the effect of a monoglyceride having a melting point of about 67° C. obtained by distilling partially hydrolyzed vegetable oil and the effect of lecithin on lauric fat at 36° C. In the absence of added emulsifier, or with added lecithin, the fat is totally melted at 36° C. With the added monoglyceride, however, the fat maintains a structure at 36° C. that can even hold a metal spatula.

The emulsifiers tested for their structure holding capacity are listed in Table 1 along with their melting point and ability to maintain the fat structure. In Table 1, a “+” sign means the emulsifier maintains good structure formation, a “−” signs means no detectable structure formation is maintained, and a “+/−” sign means the emulsifier weakly maintains structure formation.

TABLE 1
Heat Resistance of Lauric Fat and Cocoa Butter with
Several Emulsifiers

| | | | Structure |
|---|---|---|---|
| | | MP | Formation at |
| Monoglyceride | Oil | (° C.)¹ | 36° C. |
| Monolaurin (C₁₂) | LF² | 63 | — |
| Monotridecanoin (C₁₃) | LF | N/A | — |
| Monomyristin (C₁₄) | LF | 70 | — |
| Monopentadecanoin (C₁₅) | LF | N/A | — |
| Monopalmitin (C₁₆) | LF | 71(74) | +/− |
| Monoheptadecanoin (C₁₇) | LF | N/A | +/− |
| Monoestearin (C₁₈) | LF | 74 | + |
| Monononadecanoin(C₁₉) | LF | N/A | + |
| Monoarachidin (C₂₀) | LF | N/A | + |
| Monobehenin (C₂₂) | LF | (87) | + |
| Monolauroin (C₁₂) | Cocoa | 63 | — |
| | Butter | | |
| Monotridecanoin (C₁₃) | Cocoa | N/A | — |
| | Butter | | |
| Monomyristin (C₁₄) | Cocoa | 70 | — |
| | Butter | | |
| Monopentadecanoin (C₁₅) | Cocoa | N/A | — |
| | Butter | | |
| Monopalmitin (C₁₆) | Cocoa | 71(74) | — |
| | Butter | | |
| Monoheptadecanoin (C₁₇) | Cocoa | N/A | — |
| | Butter | | |
| Monoestearin (C₁₈) | Cocoa | 74 | — |
| | Butter | | |
| Monononadecanoin (C₁₉) | Cocoa | N/A | +/− |
| | Butter | | |
| Monoarachidin (C₂₀) | Cocoa | N/A | + |
| | Butter | | |
| Monobehenin (C₂₂) | Cocoa | 87 | + |
| | Butter | | |

¹Literature values. Values in parenthesis were measured in the laboratory.
²LF = lauric fat
N/A = Not available.

Monoglycerides having a side chain of 16 carbons or longer show an ability to maintain the fat structure at 36° C. Monoglycerides having a side chain of 18 carbons or longer seem to be more effective in maintaining structure of the lauric fat while monoglyceride having carbon side chains of 20 and 22 seem to be more effective at maintaining the structure of cocoa butter. Since the C20, and C22 monoglycerides are not totally soluble in the fat at temperatures of between about 30 and 40° C. they promote seeding of the fat to form a solid structure.

High melting point fats, such as cottonseed and palm stearins, are also known to promote seeding and would also give a structure to the fat. These stearins, however, remain in the solid form in the mouth and are perceived as having a “waxy” texture in the mouth at the concentrations used in the invention. In addition, the “waxy” texture of the stearins can effect flavor release from the chocolate. The monoglycerides also have high melting points, however, they also contain a hydrophilic moiety that interacts with the saliva. Therefore, using monoglycerides is preferred since they are not perceived as “waxy” in the mouth at the concentrations described in this invention.

### Example 2

Preparation and Testing of Shape Retention on a Compound Coating Bar.

A mass of a compound coating was prepared following conventional procedures of mixing, refining, and conching. Various concentrations of monoglyceride emulsifier (ranging from 1 to 4.5% of the total mass) and other high melting point emulsifiers were added to the coating as part of the fat system before conching. The monoglyceride had a melting of about 67° C. and was obtained by distilling partially hydrolyzed vegetable oil. A representative recipe for the compound coating is given in Table 2. A control compound coating contained no monoglyceride emulsifier.

TABLE 2
Recipe for Confectionery Coating

| Ingredients | Amount (%) |
|---|---|
| Ground bakers sugar | 45.3 |
| Non-fat dry milk | 17.8 |
| Cocoa butter | 6.4 |
| Lauric fat | 27.4 |
| Vanillin | 0.03 |
| Lecithin | 0.07 |
| Monoglycerides (MP ≈ 67° C.) | 3 |

After adjusting the viscosity with a minimum amount of lecithin, the mass was deposited into Kit Kat® molds, placed in a refrigerator for 30 minutes and then demolded. Alternatively, the monoglycerides were added at the end of the conching process. The compound coatings made with emulsifiers and the control coating without emulsifier were tested for shape retention using a texture analyzer. The hardness of candy bars containing the compound coatings was measured in a temperature-controlled cabinet, after 1 hr at 34° C., 36° C., or 40° C., with a TA-XT2 Texture Analyzer, equipped with a XTRAD software (commercially available from Texture Technologies Corp, of Scarsdale, N.Y.). The hardness of the coatings was measured by the puncture test. Test conditions are given below in Table 3. Taste testing of the coating was done using an informal sensory panel.

TABLE 3
Parameters of the TA-XT2 Texture Analyzer

| Parameter | Setting of Texture Analyzer |
|---|---|
| Pre-test speed | 3 mm/sec |
| Test speed | 0.1 mm/sec |
| Post-test speed | 4 mm/sec |
| Depth | 2 mm |
| Trigger force | 6 g |
| Probe | TA-55 Punch Probe |
| Attribute | Maximum Force |

The informal sensory panel did not perceive the mass containing the emulsifier component as waxy. They found the chocolate composition of the invention to be more fatty than chocolate without the emulsifier component and to be creamy and to have an acceptable texture.

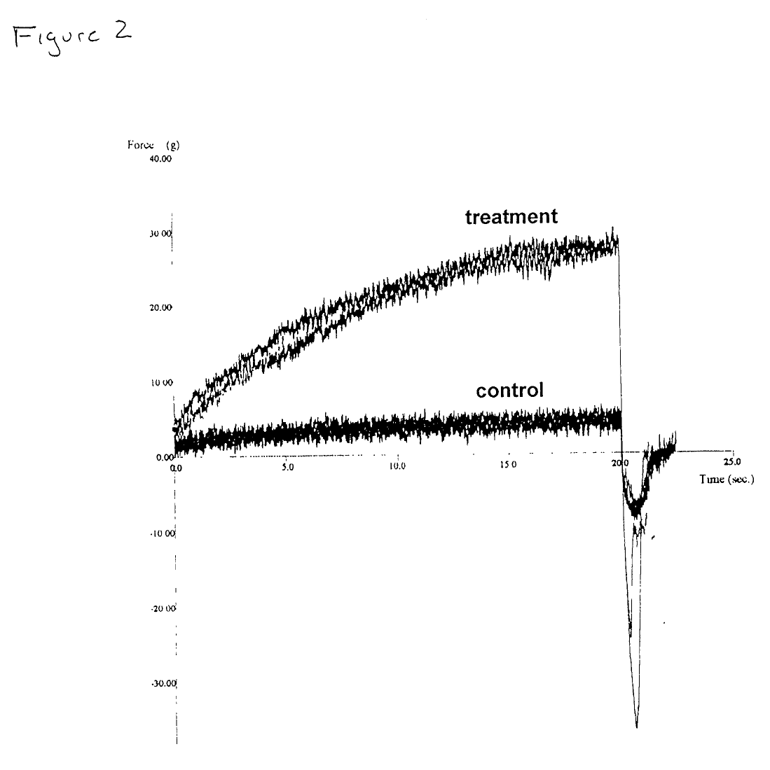

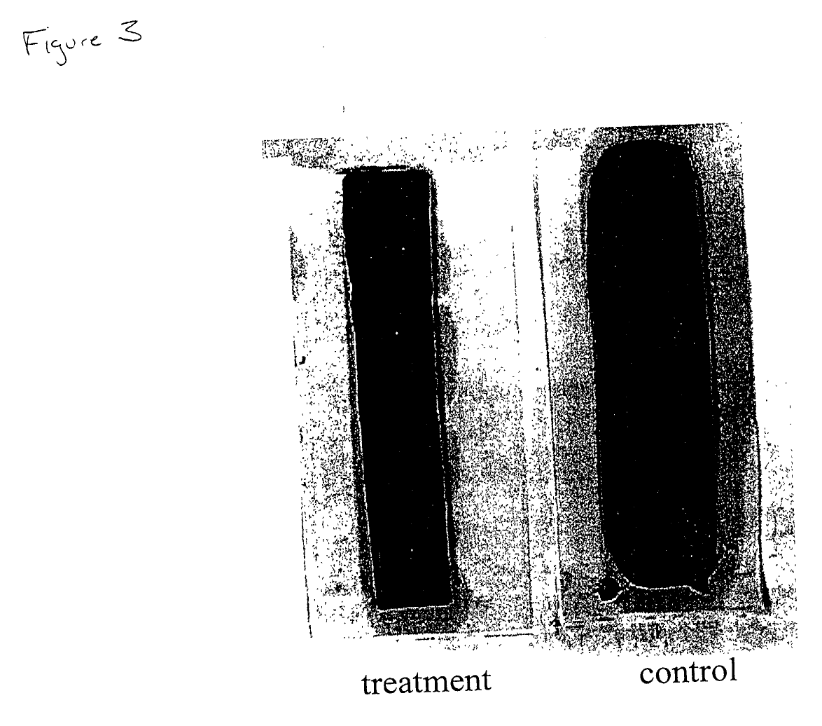

FIG. 2 shows the texture profile of a compound coating containing the monoglyceride compared to a compound coating without the monoglyceride at an elevated temperature. As can be seen in FIG. 2 the maximum force, which indicates the hardness of the coating, is much higher for samples containing the monoglyceride emulsifier. Also, when samples containing monoglyceride were tapped they retained their shape. In contrast the control, without monoglyceride, was very fluid. FIG. 3 depicts a confectionery product containing a compound coating with an emulsifier component and a confectionery product containing a compound coating without an emulsifier component at an elevated temperature. FIG. 3 shows that the confectionery product with emulsifier component is better at retaining its shape at elevated temperatures.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

What is claimed is:

1. A chocolate composition comprising an emulsifier component having a melting point from about 50 to 90° C. and a hydrophillic lipophilic balance value from about 2 to 10.

2. The chocolate composition of claim 1, wherein the emulsifier component is present in an amount of about 1 to 6 percent by weight of the confectionery product.

3. The chocolate composition of claim 1, wherein the emulsifier component comprises at least one of a diacetyltartaric acid ester of monoglycerides, sorbitan esters, mono- and diglycerides of vegetable oils, partially hydrogenated monoglycerides, fully hydrogenated monoglycerides, orsugar esters.

4. The chocolate composition of claim 3, wherein the emulsifier component is a monoglyceride having a carbon side chain of at least 18 carbons.

5. The chocolate composition of claim 4, wherein the emulsifier component comprises a monoglyceride having a carbon side chain of at least 20 carbons.

6. The chocolate composition of claim 1, wherein the emulsifier component comprises a monoglyceride having a melting point of about 67° C. obtained by distilling partially hydrolyzed vegetable oil.

7. The chocolate composition of claim 1, wherein the chocolate composition substantially maintains its structure up to a temperature of at least about 36° C.

8. The chocolate composition of claim 1, wherein the chocolate composition substantially maintains its structure up to a temperature of at least about 45° C.

9. A method of manufacturing a chocolate composition that maintains its structure at elevated temperatures comprising:
combining the ingredients of make a chocolate;
adding to the chocolate an emulsifier component having a melting point from about 50° C. to, 90° C. and hydrophillic lipophilic balance value of about 2 to 10;
mixing the chocolate and emulsifier component to sufficiently distribute the emulsifier component throughout the chocolate and provide a chocolate composition that is a mixture of chocolate and emulsifier component;
warming the chocolate composition to a temperature sufficient to inhibit or prevent the emulsifier component from crystallizing; and
allowing the mixture to cool and set to form a stable chocolate composition.

10. The method of claim 9, further comprising depositing the mixture into a mold at a temperature sufficient to prevent the emulsifier component from crystallizing, and removing the mixture from the mold after the mixture cools.

11. The method claim 9, wherein the emulsifier component is added in an amount from about 1 to 6 percent by weight of the chocolate composition.

12. The method of claim 9, wherein the mixing uniformly distributes the emulsifier component throughout the chocolate.

13. A food product comprising a liquid oil and an emulsifier component having a melting point from about 50 to 90° C. and a hydrophillic lipophilic balance value of about 2 to 10.

14. The food product of claim 3, wherein the liquid oil comprises palm oil, palm kernel oil, coconut oil, cocoa butter, babassu oil, milk fat, soybean oil, corn oil, canola oil, rapeseed oil, sesame oil, sunflower oil, safflower oil, peanut oil, oils resulting from the fractionation or hydrogenation thereof, and mixtures thereof.

15. The food product of claim 13, wherein the ratio of liquid oil to emulsifier component is about 10:2.

16. The food product of claim 13, wherein the emulsifier component comprises at least one of a diacetyltartaric acid ester of a monoglyceride, sorbitan ester, mono- or diglycerides of a vegetable oil, a partially hydrogenated monoglyceride, a fully hydrogenated monoglyceride, or sugar ester.

17. The food product of claim 16, wherein the emulsifier component comprises a monoglyceride having a carbon side chain of at least 18 carbons.

18. The food product of claim 13, wherein the liquid oil is present in an amount of about 10 to 60 weight percent of the food product and the emulsifier is present in an amount of about 0.5 to 15 weight percent of the liquid oil.

19. The food product of claim 13, wherein the food product comprises at least one of a creamer, dough, bouillon base, confectionery coating or center, or ice cream.
